(19) United States
(12) Patent Application Publication
(10) Pub. No.: US 2010/0053588 A1
(43) Pub. Date: Mar. 4, 2010

(54) Substrate Stage movement patterns for high throughput While Imaging a Reticle to a pair of Imaging Locations

(75) Inventors: Michael B. Binnard, Belmont, CA (US); Eric Peter Goodwin, Tucson, AZ (US); W. Thomas Novak, Hillsborough, CA (US); Daniel Gene Smith, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/545,487

(22) Filed: Aug. 21, 2009

Related U.S. Application Data
(60) Provisional application No. 61/093,114, filed on Aug. 29, 2008.

(51) Int. Cl. G03B 27/32

(52) U.S. Cl. 355/77

(57) ABSTRACT

A new and useful optical imaging process is provided for imaging of a plurality of substrates, in a manner that makes efficient use of an optical imaging system with the capability to image a single reticle to a pair of imaging locations, and addresses the types of substrate stage movement patterns to accomplish such imaging in an efficient and effective manner. At least three substrates are imaged by moving their substrate stages in patterns whereby (i) two of the substrates are completely imaged at respective imaging locations, (ii) a substrate on at least one of the three stages is partially imaged at one imaging location and then partially imaged at the other imaging location, and (iii) the movement of the stages of the three substrates is configured to avoid movement of the stages of the three substrates in paths that would cause interference between movement of any one substrate stage with movement of any of the other substrate stages.

### RELATED APPLICATIONS/CLAIM OF PRIORITY

This application is related to and claims priority from provisional application Ser. No. 61/093,114, filed Aug. 29, 2008, which provisional application is incorporated herein by reference.

### BACKGROUND

The present invention relates to a process that enables substrates to be imaged from a reticle that is imaged to a pair of imaging locations, in a manner that improves the throughput of such a system.

In the field of optical lithography, the reticle is often the most expensive component needed for the printing (i.e., imaging) of substrates. One technique that has been proposed for creating a high throughput system is to have an imaging optical system with a single reticle on a single reticle stage with an imaging optical system that images two portions of the reticle onto two separate substrates, thus increasing the number of substrates that are “imaged” (“printed”, “exposed”) with a given reticle in one exposure machine per unit time. FIGS. 1 and 1a represent such an imaging optical system, which is a proprietary system of the assignee of this application. This imaging optical system may be referred to in this application as the Sumo lens. Provisional application for the Sumo lens has been filed on Aug. 29, 2008, as application Ser. No. 61/093,104, and that provisional application is incorporated by reference herein.

The imaging optical system illustrated in FIGS. 1, 1a is a Catadioptric projection imaging optical system, with a numerical aperture (NA) of 1.35, and a 26×5 mm image field; the Sumo lens referred to above.

In the applicants' experience, the Sumo lens requires at least two substrate stages to remain viable from a throughput improvement standpoint, so that two substrates can be imaged (e.g. simultaneously) from the same reticle.

Applicants also recognize that with a system using a single imaging location, throughput can be improved by using two substrate stages; one to image while the other loads a substrate and performs the necessary metrology, minimizing the time that the lens is not printing to merely the time it takes to exchange the two substrate stages at the imaging location. If this technique were applied directly to the Sumo lens, the system would require 4 substrate stages. The present invention relates to a technique (method) that preferably uses 3 substrate stages, in a configuration and in a process that provides a way of imaging a plurality substrates from the single reticle at a pair of imaging locations.

One complication applicants have addressed, in the development of the technique of the present invention, has to do with the cables, wires and tubes (generally referred to in this application as “cables”) running to each stage which are necessary for power, cooling, etc. It is important that these cables never have to cross as the system images multiple substrates. The present invention provides a method for accomplishing this objective.

### SUMMARY OF THE PRESENT INVENTION

The present invention provides an optical imaging process for imaging substrates on at least three substrate stages, in a manner that enables at least two substrates to be imaged from a single reticle, at a pair of imaging locations, and addresses the foregoing issues.

According to the present invention a plurality of substrates are imaged from a single reticle, at a pair of imaging locations, in a manner such that at least one of the substrates is partially imaged at one imaging location, and the remainder of the substrate is imaged at the other imaging location. In an exemplary process, using the principles of the present invention, three substrates are imaged by moving their substrate stages in patterns whereby (i) respective parts of two substrates are completely imaged at respective imaging locations, (ii) a substrate on at least one of the three stages is partially imaged at one imaging location and then the remainder of the substrate is imaged at the other imaging location, and (iii) the movement of the stages of the three substrates is configured to avoid movement of the stages of the three substrates in paths that would cause interference between movement of any one substrate stage with movement of any of the other substrate stages.

A system set up preferably comprises at least one metrology region, either a single substrate load/unload station or a plurality of substrate load/unload stations, the optical imaging system with the pair of imaging locations, and three substrate stages that are moved between the metrology region, the pair of imaging locations and the load/unload station(s) in a manner designed to enable the pair of imaging stations to image substrates at the pair of imaging locations. The optical imaging process is designed to enable as efficient use of the imaging locations as possible, so that (except for short time periods that substrate stages may be in transit between imaging locations, or for other operations where imaging at one or both imaging locations needs to stop, such as, e.g., system calibration, reticle alignment or reticle loading, aligning a wafer to the imaging optics and reticle after a metrology operation), the pair of imaging locations are being used to simultaneously image respective pairs of the substrates a majority of the time. Thus, in this application, reference to the pair of imaging locations as simultaneously imaging substrates is intended to encompass a process that allows for the short time periods that substrate stages may be in transit between imaging locations, or for the periods that imaging at one or both imaging locations needs to stop for an operation of the type described above.

In this application, reference to a substrate being “imaged”, “exposed”, “printed”, etc. at an imaging location, preferably means that a photoresist on the substrate has a predetermined pattern optically transferred from a reticle (“mask”) to the photoresist, in the process of producing a semiconductor wafer.

Additional aspects of the present invention will be further apparent from the following detailed description and the accompanying drawings.

### BRIEF DESCRIPTION OF THE DRAWINGS

FIG. 1 schematically illustrates a Catadioptric projection optics, NA 1.35, 26×5 mm image field; the Sumo lens referred to above;

FIG. 1a is a schematic illustration of the top of the reticle of FIG. 1, taken from the direction 1a-1a;

FIG. 2 schematically illustrates a layout for imaging three substrates, according to the principles of the present invention;

FIGS. 3a-3e schematically illustrates the manner in which the substrate stages are moved relative to each other, using the layout of FIG. 2, to enable three substrates to be imaged in accordance with the principles of the present invention;

FIG. 4 schematically illustrates the general alignment of the substrate stages, the imaging locations and the metrology region, in relation to Displacement Measuring Interferometer (DMI) beams that could be affected by that alignment;

FIG. 5 schematically illustrates one way the alignment issue illustrated in FIG. 4 can be addressed;

FIG. 6 is a schematic side view of a pair of the substrate stages, that further shows how the alignment issues illustrated in FIG. 4 can be addressed;

FIG. 7 schematically illustrates additional ways of addressing the alignment issues illustrated in FIG. 4; and

FIGS. 8a-8e and FIGS. 9a-9e schematically illustrate another layout for imaging three substrates, according to the principles of the present invention, and show two different substrate stage movement patterns by which the substrate stages are moved relative to each other, during the imaging of the substrates on the substrate stages, to enable three substrates to be imaged in accordance with the principles of the present invention, using the layout and the movement patterns shown in FIGS. 8a-8e or 9a-9e. Red arrows in FIG. 8C show an alternative motion for B and C.

### DETAILED DESCRIPTION

As described above, the present invention provides a new and useful optical imaging process for utilizing a pair of imaging locations to image a reticle to a plurality of substrates, each of which is carried by a respective stage. A system set up preferably comprises at least one metrology region, substrate load/unload station(s) (either a single load/unload station or a pair of load/unload stations), optical imaging of a reticle to the pair of imaging locations, and three substrate stages that are moved between the metrology region, the pair of imaging locations and either the single load/unload station or the pair of load/unload stations in a manner designed to enable the pair of imaging stations to image substrates at the pair of imaging locations. The optical imaging process is designed to enable as efficient use of the imaging locations as possible, so that (except for short time periods that exposure needs to stop at one or both imaging locations), the pair of imaging locations are preferably being used to simultaneously image respective pairs of the substrates. Some examples of time periods where exposure needs to stop at one or both imaging locations, include (but are not limited to) (i) times when substrate stages may be in transit between imaging locations, (ii) during reticle alignment, (iii) during timer periods that the wafer is being aligned with the imaging optics and reticle after metrology operation, (iv) during optical calibration. Moreover, the movement patterns of the three substrate stages is configured to provide that a pair of the substrate stages are located at the pair of imaging locations a majority of the time (allowing for the time periods that imaging may need to be stopped at one or both imaging locations), so that imaging is being simultaneously performed at the pair of imaging stations at a majority of the time during the operation of the process. Thus, in this application, reference to the pair of imaging locations as “simultaneously” imaging substrates, or to a pair of substrate stages as located at the pair of imaging locations a majority of the time, is intended to encompass a process that allows for the time periods that imaging is stopped at one or both imaging locations to allow for the types of operations described above.

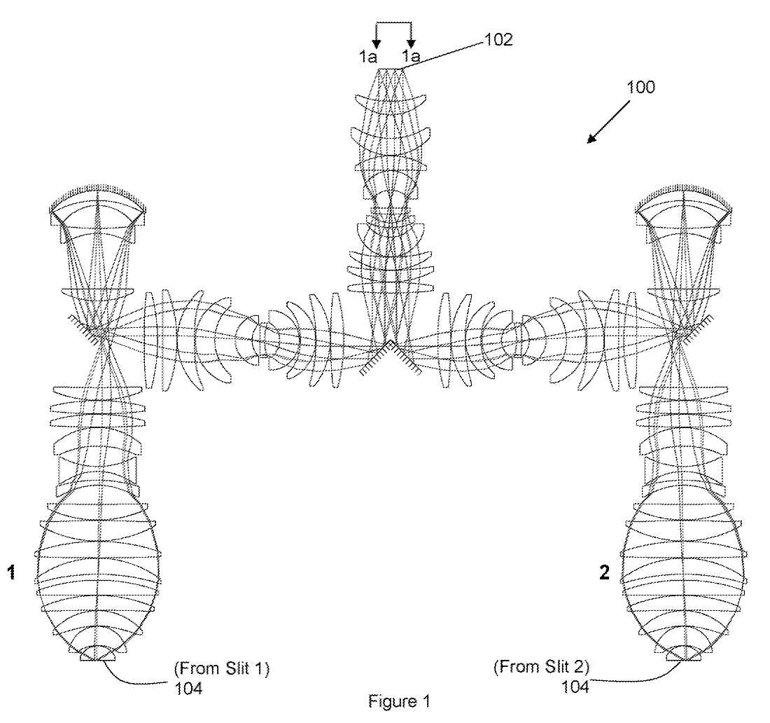

FIGS. 1 and 1a schematically illustrate a preferred optical imaging system (known as the Sumo lens) for simultaneously imaging portions of two substrates from a single reticle, in accordance with the provisional application Ser. No. 61/093,104 that has been incorporated by reference herein. As illustrated in FIGS. 1 and 1a, portions of a single reticle 102 are imaged to a pair of image planes 104 at imaging locations 1 and 2 of the optical imaging system. The reticle 102 can move in the manner illustrated in FIG. 1a, and the reticle is illuminated in the regions labeled 1 and 2, which are imaged to respective image planes 104 (associated with slits 1 and 2, respectively) in the manner illustrated in FIG. 1.

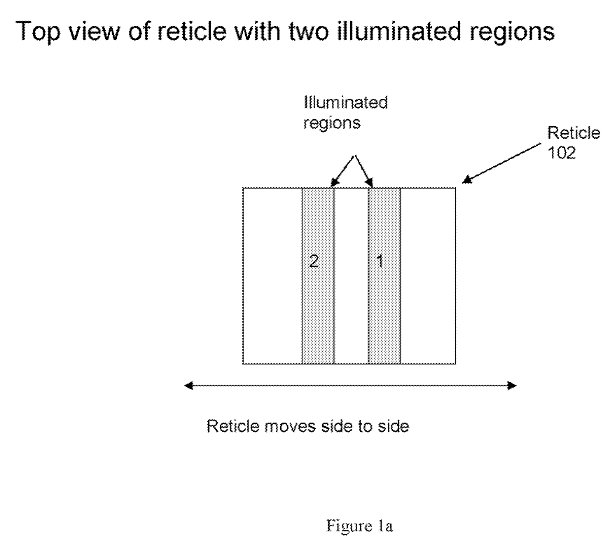

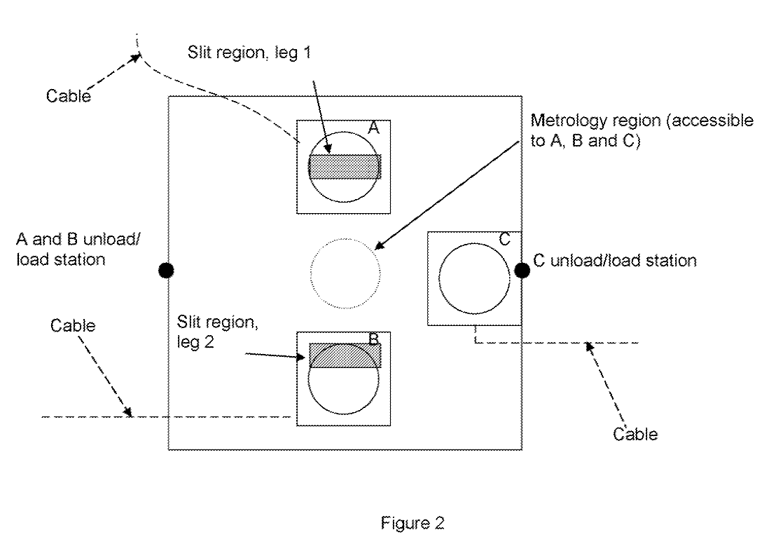

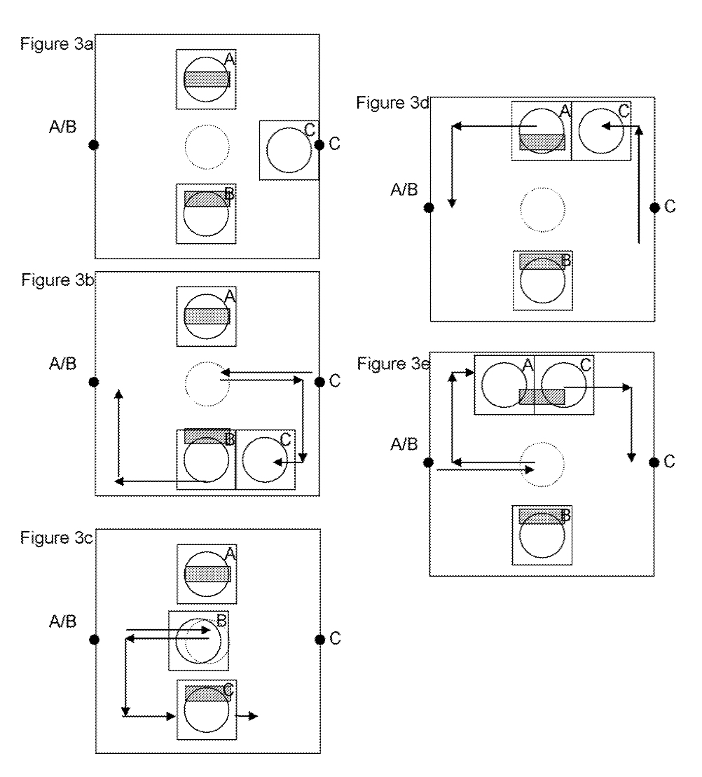

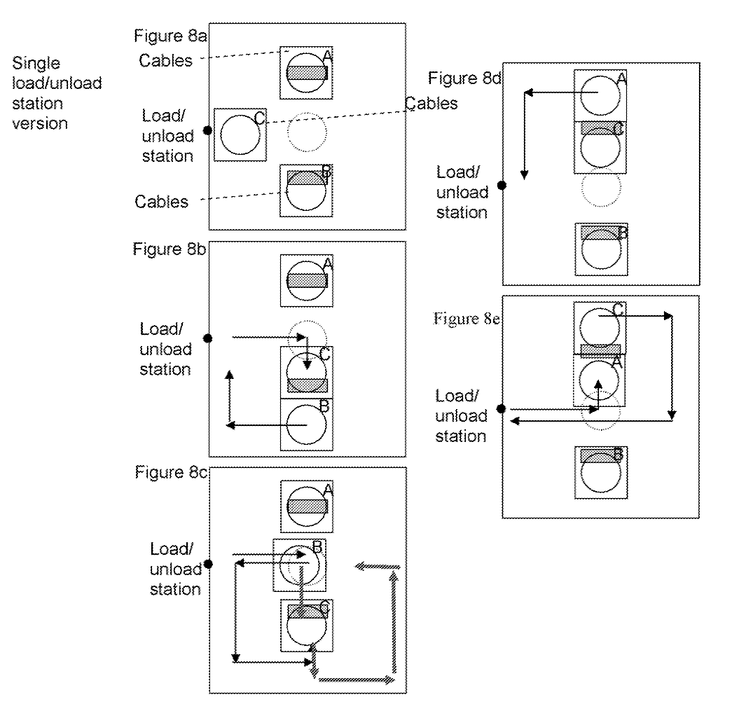

FIGS. 2 and 3a-e schematically show one embodiment of an overall system set up, and the manner in which an optical imaging process is practiced in accordance with the principles of the present invention, using that system set up. The system set up of FIGS. 2 and 3a-3e utilizes a pair of load/unload stations, whereas an alternative system set up (shown and described later in this application in connection with FIGS. 8a-e and 9a-e) utilizes a single load/unload station. Alternatively, as will be appreciated by those skilled in the art, it is also possible, although not preferred in most applications, to have more than two load/unload stations.

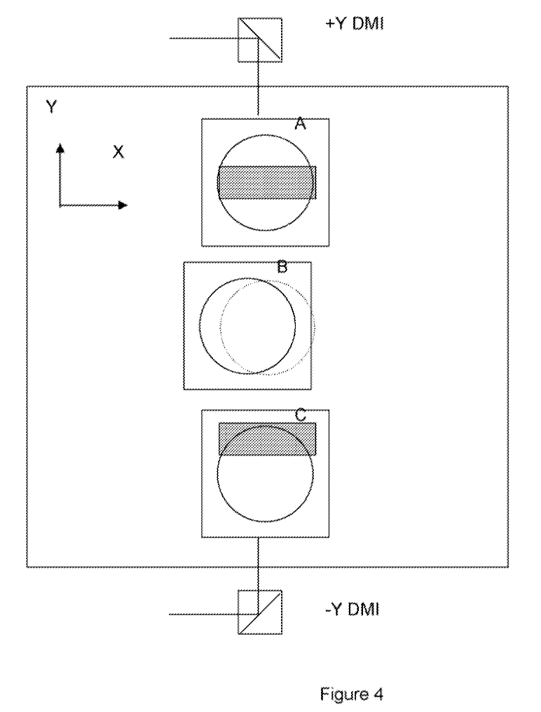

It should be noted that in FIGS. 2 and 3a-e (and also in FIGS. 4, 8a-e and 9a-e) the darker line areas (labeled “slit region, leg 1” and “slit region, leg 2” in FIG. 2) are shown much larger then they would normally be configured, in order to illustrate the principles of the present invention. However, in actual practice, the slit regions would be considerably smaller than as shown, as will be appreciated by those in the art

Referring to FIG. 2, the system set up includes
a. The pair of optical imaging locations where optical imaging of the single reticle 102 to substrates at those locations occurs (in FIG. 1, the imaging locations are generally referenced at “1” and “2”, and in FIG. 2, the imaging locations are referred to as “slit region, leg 1” and “slit region, leg 2”).
b. A metrology region (referred to in FIG. 2 as “Metrology region”).
c. A pair of load/unload stations (referred to as “C unload/load station” and “A and B unload/load station”) where substrates are loaded and/or unloaded to substrate stages (that are identified in FIG. 2 and FIGS. 3a-3e as A, B, and C).

The substrate stages A, B and C have cables connected with those stages, and the orientation of those cables is schematically illustrated in FIG. 2. The notion of a “cable”, as used in this application, any of the different types of cables, wires, connectors, tubes, etc. (e.g. electrical, optical, hydraulic, etc) that would typically be associated with a substrate stage, as is well known to those in the art.

It should also be noted that in the system set up of FIG. 2, the imaging locations and metrology region are in a linear alignment, with the metrology region disposed between the imaging locations (that arrangement is referred to in this application as the “linear alignment”). Moreover, the C load/unload station is on one side of the linear alignment and the A/B load/unload station is on the other side of the linear alignment. The linear alignment, while providing one useful orientation of metrology area and imaging locations, is not an essential requirement of the process of this invention, and other locations of the metrology area, or a configuration comprising multiple metrology areas, are also possible embodiments of this invention, as will be appreciated by those in the art.

The foregoing system set up, and the substrate stage movement patterns described herein, is designed to provide efficient, preferably simultaneous imaging of two substrates at the two imaging locations, while avoiding the cable from one substrate stage from interfering with (e.g. wrapping about or otherwise interfering) with a cable from any other substrate stage.

The optical imaging system that is schematically shown in FIGS. 1 and 1a has an inverted Y configuration, which images two substrates from a single reticle in a manner such that respective parts of the reticle are used to image two imaging locations, each of which can image a complete substrate, or a respective part of a substrate. The metrology region is provided for examining a substrate (e.g. enable alignment and/or other measurements of the substrate on the substrate stage), and three substrates are imaged by moving the substrates in patterns whereby as one substrate is being examined at the metrology region, the other two substrates (or portions of substrates) are being imaged at the two imaging locations, and the movement of the three substrates between the metrology region and the imaging locations is designed to avoid movement of the three substrate stages in paths that would cause movement of any one substrate stage to interfere with the path of movement of any of the other substrate stages. Additionally, the movement pattern of the substrate stages is designed such that three are imaged by moving the substrate stages in patterns whereby (i) two substrates can be completely imaged at respective imaging locations, (ii) a substrate on at least one of the stages is partially imaged at one imaging location and then partially imaged at the other imaging location, and (iii) the movement of the stages is configured to avoid movement of the stages in paths that would cause interference between movement of any one substrate stage with movement of any of the other substrate stages.

The Sumo lens optical imaging system is shown at 100 (illustrated in FIG. 1), and comprises a catadioptric optical imaging system configured to image respective the portions of the single reticle 102 to a pair of substrates that would be located at respective image planes 104 of the system. These image planes are the imaging locations where the portions of the reticle are imaged to substrates at those imaging locations. The method of the present invention preferably uses a Sumo lens according to FIGS. 1 and 1a to image respective portions of the single reticle 102 to pairs of substrates at the imaging locations, via the catadioptric optical imaging system of FIGS. 1, 1a. Of course other lens configurations that provide imaging onto two exposure areas are possible. For example, a dioptric (all-refractive) system could be used for a lower Numerical Aperture exposure machine. Such a dioptric system could include planar fold mirrors, as will be recognized by those in the art.

FIG. 2 shows an arbitrary starting positions for 3 substrate stages and FIGS. 3a-3e show the full patterns and sequence for loading, measuring, printing (also referred to as “imaging” or “exposing”) and unloading substrates using three substrate stages. In FIG. 3a, a substrate on substrate stage A is starting exposure at the first imaging location, a substrate on substrate stage B is already half exposed at the second imaging location, and substrate stage C is loading a new substrate. After loading the substrate, substrate stage C moves the substrate under the metrology region. When the substrate on B has finished exposing at the second imaging location, substrate stage C moves in to displace substrate stage B at the second imaging location (by the “stage swap procedure” described below), substrate stage B moves to the A/B unload station, while substrate stage A continues exposing a substrate at the first imaging location (FIG. 3b).

In FIG. 3c, the substrate on substrate stage B has finished the required metrology and substrate stage B moves to displace substrate stage C (which has a substrate whose exposure is now half completed) from under the second imaging location (by the “stage swap procedure” described below). The substrate on substrate stage A has finished exposing at the first imaging location, and substrate stage C continues over to displace substrate stage A at the first imaging location (by the “stage swap procedure” described below), so that the second half of the exposure of the substrate on stage C is completed at the first imaging station, i.e. under leg 1 of the sumo lens (FIG. 3d). This step prevents cables from crossing. Substrate stage A moves left and down (as seen in FIGS. 3a-3e) to the A/B unload station.

In FIG. 3e, the substrate on substrate stage A has finished metrology at the metrology region, and substrate stage A moves to the first imaging location under leg 1 of the Sumo lens, to begin exposure of the substrate on substrate stage A, displacing substrate stage C, which has a substrate whose exposure has just finished at the first imaging location.

It should be noted that the procedure by which substrate stage A displaces substrate stage C at the first imaging location and begins exposure of the substrate on stage A at the first imaging location, is referred to as “stage swap.” This procedure involves moving the two stages close together so they form a substantially continuous surface (e.g. as shown in FIG. 3e) and move them in the manner illustrated, where the stages move together in order to maintain an immersion liquid in the gap under the projection lens (at an imaging location) as imaging is switched from the substrate on stage C to the substrate on stage A. An example of the stage swap procedure is shown and described in U.S. Pat. No. 7,327,435, which is owned by the assignee of the present application, and is incorporated herein by reference. Thus, reference to a “stage swap” in this application is intended to mean the type of procedure illustrated in FIG. 3e (and in U.S. Pat. No. 7,327,435) by which the substrate stages move together and immersion liquid is maintained in the gap under the projection lens (at an imaging location) as imaging switches from a substrate on one stage to a substrate on another stage at the imaging location. A similar stage swap procedure is schematically shown in FIG. 3b, as substrate stage C displaces substrate stage B at the second imaging location, in FIG. 3c, as substrate stage B displaces substrate stage C at the second imaging location, and in FIG. 3d, as substrate stage C displaces substrate stage A at the first imaging location. Of course in a non-immersion lithography machine the stages can be spaced somewhat further apart during the stage swap motion, as will be appreciated by those in the art.

As further seen from FIG. 3e, after the substrate on stage C has been fully imaged, Substrate stage C moves to the stage C unload station. Substrate stage B stays under leg 2 at the second imaging location, to enable exposure of the second half of the substrate on substrate stage B. Thus, the cycle has returned to the positions shown in FIG. 3a and the cycle begins anew. Since this is a repetitive cycle, the selection of which configuration is considered the “start” and “end” is arbitrary.

The substrate on substrate stage A is fully exposed at the first imaging location, under leg 1 of the Sumo lens, while the substrate on substrate stage B is fully exposed at the second imaging location under leg 2 of the Sumo lens.

The substrate on stage C is partially (preferably half) exposed at the second imaging location under leg 2 of the Sumo lens, and its exposure is completed at the first imaging location, under leg 1 of the Sumo lens. The transition between the two imaging locations under the legs of the Sumo lens will add additional overhead time only every third substrate. Only two substrate load/unload stations are used, and only a single metrology region is needed, assuming it can be placed between the two legs of the Sumo lens and does not interfere with the two substrates that are being imaged on either side of the metrology region. The time available to unload a finished substrate, load a new substrate, perform metrology, and move into position for imaging is half of the exposure time. In applicants' experience, this is not a very restrictive limitation.

Thus, the present invention, as described above, provides a method for using at least three substrate stages under two imaging locations to maximize the amount of time that each imaging location spends exposing while preventing any necessary cables used to power and control the substrate stages from crossing each other and interfering with movement of the substrate stages in the manner described herein. This is an important aspect of realizing a two imaging location system, such as can be provided with the Sumo lens. This technique enables higher throughput and more efficient use of expensive reticles compared to existing lithography machine designs.

Accordingly, in an optical imaging process of the invention, the system set up can be provided as shown in FIG. 2 and described above, which is one way of imaging substrates in accordance with the principles of the present invention. The substrate stages are then moved, in the patterns described herein, where the general movement patterns for each of the three substrate stages comprises movement of a substrate stage from a loading station to a metrology station, movement of the stage from the metrology station to one of a pair of imaging locations and movement of the stage from the one of the pair of imaging locations, to the other of the pair of imaging locations or to a load/unload station for the substrate stage. Depending on the specific requirements of a particular machine, variations of the stage motions shown in FIGS. 3a-3e are possible within the scope of this invention. For example, in FIGS. 3a-3e, the stage swap motions are oriented in the X direction (left and right in the figures). It is also possible for these motions to be in the Y direction (up and down in the figures). Different choices for the stage swap motions allows a tradeoff between the overall size of the exposure machine and the details of the timing and throughput optimization.

More specifically, the movement patterns of the three substrate stages, and imaging of substrates at the pair of imaging locations, comprises
a. beginning imaging of a substrate on a first stage at a first imaging location, while a substrate on a second stage is being imaged at a second imaging location, and a substrate is being loaded to a third substrate stage at a load/unload station;
b. moving the third substrate stage to a metrology region, while finishing imaging of a substrate on the second substrate stage at the second imaging location, and imaging of a substrate on the first substrate stage continues at the first imaging location;
c. as imaging of a substrate on the second stage is finished at the second imaging location, the third stage moves a substrate from the metrology region to the second imaging location by the stage swap procedure, where partial imaging of the substrate on the third stage begins, the second stage moves a finished substrate to a load/unload location, where the finished substrate is unloaded from the second stage and a new substrate is loaded on the second stage and moved by the second substrate stage to the metrology region;
d. as the new substrate on the second substrate stage finishes at the metrology region, the second substrate stage moves to the second imaging location, to displace the third substrate stage by the stage swap procedure described above (where substrate imaging is only partially completed);
e. as imaging of a substrate on the first substrate stage is finished at the first imaging location, the third substrate stage moves to replace the first substrate stage under the first imaging location by the stage swap procedure described above, the first substrate stage moves to a load/unload station, imaging of a substrate on the third substrate stage is resumed at the first imaging location;
f. a finished substrate is unloaded from the first substrate stage, a new substrate is loaded to the first substrate stage which moves to the metrology region, as imaging of the substrate on the third substrate staged is completed at the first imaging location, and imaging of a substrate on the second substrate stage is continuing at the second imaging location;
g. as metrology of a substrate on the first substrate stage is completed, the first substrate stage moves to the first imaging location, displacing the third substrate stage by the stage swap procedure described above, imaging of the substrate on the first substrate stage begins, and the third substrate stage moves the finished substrate on the third substrate stage to a load/unload station; and
h. this returns the cycle to the state described in section a above, where the cycle of processing of substrates on the first, second and third substrate stages can continue in the manner described above.

Another way of viewing the moving pattern of the substrate stages is as follows:
a. the movement pattern of the first substrate stage is such that the first substrate stage moves in a pattern from the first imaging location to a load/unload station, to the metrology region and then back to the first imaging station, and imaging of the entire substrate on the first substrate stage is effected at the first imaging location;
b. the movement pattern of the second substrate stage is such that the second substrate stage moves from the second imaging location to a load/unload station, to the metrology region and then back to the second imaging station, and imaging of the entire substrate on the second substrate stage is effected at the second imaging location; and
c. the movement pattern of the third substrate stage is such that the third substrate stage moves from a load/unload station to the metrology region, then to the second imaging location where partial imaging of the substrate on the third substrate stage is effected, and then to the first imaging location, where completion of imaging of the substrate on the third substrate stage is effected.

As will be apparent to those in the art, the foregoing movement patterns of the three substrate stages is designed to avoid one substrate stage (and particularly the cable associated with that substrate stage) from interfering with (e.g. causing its cable to wrap about the cable associated with) the movement pattern of any of the other substrate stages. At least three substrates are imaged by moving the substrate stages in patterns whereby (i) two of the substrates are completely imaged at respective imaging locations, (ii) a substrate on at least one of the stages is partially imaged at one imaging location and then partially imaged at the other imaging location, and (iii) the movement of the stages of the substrates is configured to avoid movement of the stages in paths that would cause interference between movement of any one substrate stage with movement of any of the other substrate stages. These principles of the present invention can be practiced with one or a plurality of load/unload stations, one or more metrology regions in various locations, and different directions of motion of the substrate stages for the stage swap movements.

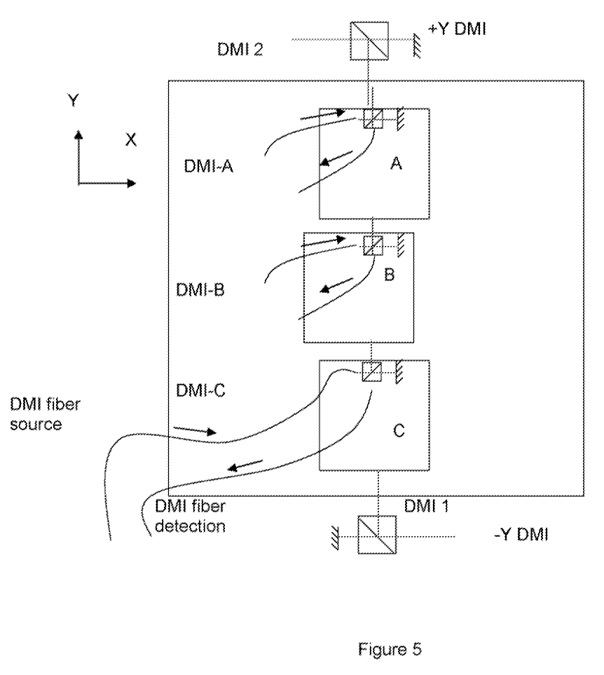

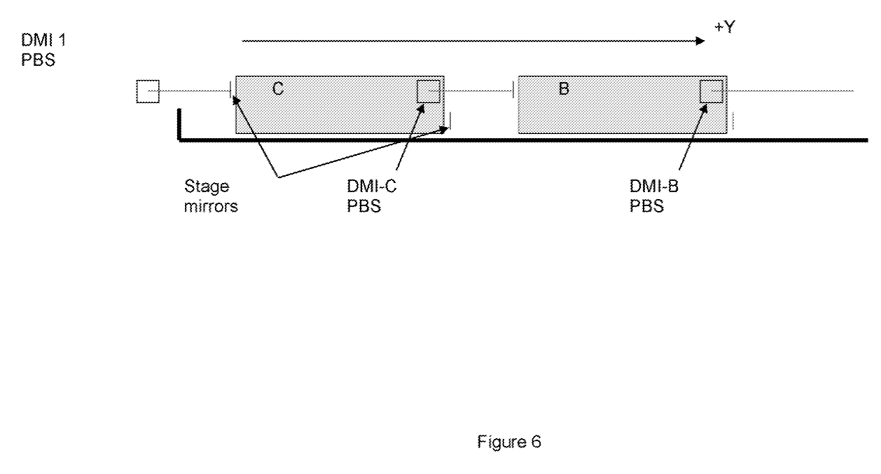

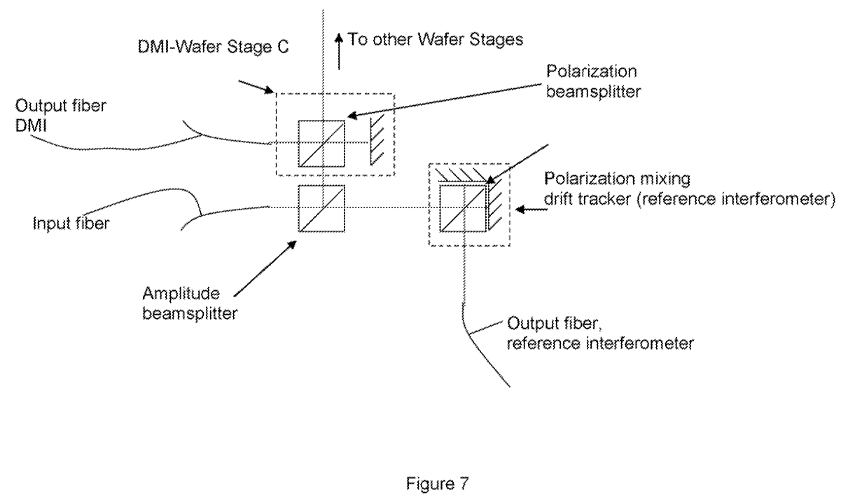

Some additional concepts for practicing the principles of the present invention are shown in FIG. 4-7. FIG. 4 schematically illustrates the general alignment of the substrate stages, the imaging locations and the metrology region, in relation to distance measuring interferometer (DMI) beams that could be affected by that alignment; FIG. 5 schematically illustrates one way the alignment issue illustrated in FIG. 4 can be addressed; FIG. 6 is a schematic side view of a pair of the substrate stages, that further shows how the alignment issues illustrated in FIG. 4 can be addressed; and FIG. 7 schematically illustrates additional ways of addressing the alignment issues illustrated in FIG. 4. As shown in FIG. 4, the Y position of substrate stage B cannot be easily measured by distance measuring interferometer (DMI) beams mounted at the +Y or −Y edges of the substrate stage base. As shown in FIG. 5, the Y-position of substrate stage B is measured by using either (a) a combination of DMI 1 and DMI-C, or (b) a combination of DMI 2 and DMI-B (In this case, it should be noted that the position of substrate stage A is measured by DMI 2). The side view of FIG. 6 shows the staggered height of the stage mirrors to enable this technique to work. In addition, FIG. 7 shows how adding a simple reference interferometer to each substrate stage (one substrate stage is illustrated in that Figure) allows tracking and correction of false motion due to polarization mixing in the moving input fiber.

More specifically, according to the concepts of FIGS. 4-7, it is recognized that there will be periods of time during the proposed motion patterns that the three stages will be roughly aligned along a line in Y, as shown in FIG. 4. During these times, the middle stage Y-position cannot be measured by a distance measuring interferometer (DMI) beam incident on a side stage mirror from the −Y or +Y directions since the beams would be blocked by the other two substrate stages. This issue is addressed by providing each stage with one (or more) DMI systems, where the laser source is preferably provided via an optical fiber in the cable bundle used to supply power and other things to the substrate stage. Alternatively, the laser light could be directed to the substrate stage through the air by mirrors in a manner which is well known in the art.

The detection of a DMI signal can be done via fiber (one such fiber associated with substrate stage C is labeled “DMI fiber detection” in FIG. 5 and similar fibers are shown in connection with substrate stages A and B, or by an electrical detection signal described below. Either technique would provide a detection signal to a processing system. These substrate stage mounted DMI systems would measure the distance between neighboring stages, where an absolute position is determined during an exchange as substrate stage B passes behind substrate stage C, as shown in FIG. 4.

If each stage has one DMI system with the same configuration, where the measurement beam is sent in the +Y direction, then the Y-position of substrate stage B is known relative to both substrate stage A and substrate stage C. Using the appropriate combinations of DMI signals, this provides two independent measurements of the position of substrate stage B. The redundant measurements can be used to partially compensate for measurement errors or mechanical deformation of the substrate stages.

One drawback is that the uncertainty of either of these two measurements will be larger then a single DMI channel since the total uncertainty of the two DMI beams used to make the measurement will be larger then the uncertainty of either component channel alone. However, the deadpath is shorter then it would be for monitoring from the edge of the substrate table. This advantage could be decreased by changes in the dimensions of the substrate stages due to temperature, for example, which would look like a motion of substrate stage B.

Finally, this technique requires stage mirrors on the +Y and −Y sides of each substrate stage. These must be at a different height so that the DMI systems on the +Y sides of each substrate stage do not interfere with the stage mirrors (see FIG. 6).

Another issue that is addressed herein is with regards to fiber coupling the signal through a moving fiber onto the stage, and the possibility of polarization mixing. Polarization mixing can induce a false motion into the detected DMI signal. This would likely be impossible to predict and correct for, since the effect would likely change as the substrate stage moved. However, adding a reference interferometer to each substrate stage (in the manner illustrated in FIG. 7) allows the effects of the polarization mixing to be accurately measured and subsequently subtracted from the measured stage position. Since the two mirrors of the reference interferometer are attached to the polarization beam splitter, any signal change in the reference interferometer can be attributed to polarization mixing.

An alternative way of addressing the foregoing issue is to have the signal detected on the substrate stage (via a detector on the substrate stage), and to have an electrical signal carried by a wire, off the substrate stage and to a processing system.

Thus, the Y-position of the middle of three substrate stages can be tracked on a single substrate table when the standard DMI beams are blocked by the front and back substrate stages. This allows measurement of the Y-position of all three substrate stages for any set of positions on the substrate table. Reference interferometers can be provided on each substrate stage to allow compensation for polarization mixing induced by the moving optical input fibers. Tracking the middle of the three substrate stages is accomplished by means of distance measuring interferometer beams associated with each of the three substrate stages, each distance measuring interferometer beam configured to avoid interference from the distance measuring interferometer beams associated with the other stages. Moreover, each substrate stage may also have a reference interferometer that enables tracking and correction of false motion due to polarization mixing in a moving source fiber that directs a measurement beam toward a stage mirror on the substrate stage. Additionally, the detection can be provided on the substrate stage, and an electrical signal can be used to carry the detection signal off the substrate stage.

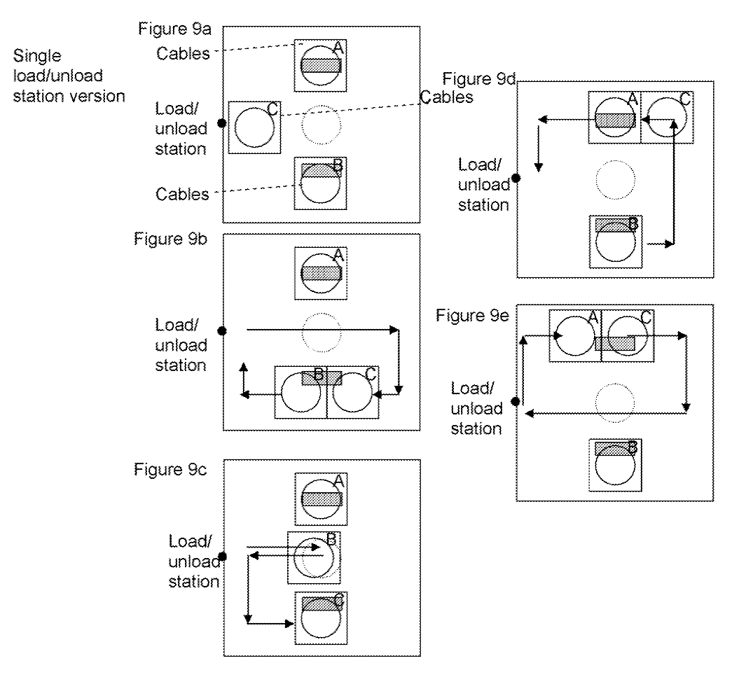

FIGS. 8a-8e and 9a-9e show an alternative system set up that utilizes a single load/unload station, and also illustrate two different patterns of movement of substrate stages for the alternative system set up. The alternative system set up, and the movement patterns of the substrate stages of FIGS. 8a-8e and 9a-9e, are designed to simultaneously image pairs of substrates at the two imaging locations (e.g. the two imaging locations of the Sumo lens of FIGS. 1 and 1a), while utilizing a single load/unload station for each of the substrate stages A, B and C.

Thus, in FIG. 8a, a substrate on substrate stage A is starting exposure at the first imaging location, a substrate on substrate stage B is already half exposed at the second imaging location, and substrate stage C is loading a new substrate at the single load/unload station. After loading the substrate, substrate stage C moves the substrate under the metrology region. When the substrate on B has finished exposing at the second imaging location, substrate stage C displaces substrate stage B, via the stage swap procedure described above, so that imaging of the substrate on stage C begins at the second imaging location, and substrate stage B moves to the single load/unload station, while substrate stage A continues exposing a substrate at the first imaging location (FIG. 8b). Two patterns of movement of substrate stages B and C between the metrology region and the second imaging location are illustrated in FIG. 8c by two sets of arrows, (and those same two patterns of movement of substrate stages B and C can also be used in the example of FIG. 9c, below, or in the example of FIG. 3c above).

In FIG. 8c, the substrate on substrate stage B has finished the required metrology and substrate stage B moves around to displace substrate stage C at the second imaging location, via the stage swap procedure described above.

Substrate stage C, which has a substrate whose exposure is only half completed moves out from under the second imaging location. The substrate on substrate stage A has finished exposing at the first imaging location, and substrate stage C continues over to displace substrate stage A at the first imaging location, via the stage swap procedure described above, so that the second half of the exposure of the substrate on stage C is completed at the first imaging station, i.e. under leg 1 of the sumo lens (FIG. 8d). This step prevents cables from crossing as substrate stage A moves left and down to the single load/unload station.

In FIG. 8e, the substrate on substrate A has finished metrology at the metrology region, and substrate stage A moves to the first imaging location under leg 1 of the Sumo lens, to displace substrate stage C (via the stage swap procedure described above) which has a substrate whose exposure is finished, and to begin exposure of the substrate on substrate stage A at the first imaging location. As further seen from FIG. 8e, after the substrate on stage C has been fully imaged, Substrate stage C moves to the single load/unload station via a path by which it passes through the metrology region. Substrate stage B stays under leg 2 at the second imaging location, to enable exposure of the second half of the substrate on substrate stage B. Thus, the cycle has returned the substrate stages to the positions shown in FIG. 8a and the cycle begins anew. Only a single substrate load/unload station is used for loading and unload all three substrate stages, and only a single metrology region is provided, that is located placed between the two legs of the Sumo lens and does not interfere with the two substrates that are being imaged simultaneously on either side of the metrology region.

In FIG. 9a, a substrate on substrate stage A is starting exposure at the first imaging location, a substrate on substrate stage B is already half exposed at the second imaging location, and substrate stage C is loading a new substrate at the single load/unload station. After loading the substrate, substrate stage C moves the substrate under the metrology region. When the substrate on B has finished exposing at the second imaging location, substrate stage C displaces substrate stage B at the second imaging location, via the stage swap procedure described above, and via the path shown in FIG. 9b, which is a different path than the path shown in FIG. 8b, so that imaging of the substrate on stage C begins at the second imaging location, and substrate stage B moves to the single load/unload station, while substrate stage A continues exposing a substrate at the first imaging location (FIG. 9b).

In FIG. 9c, the substrate on substrate stage B has finished the required metrology and substrate stage B moves around to displace substrate stage C at the second imaging location, via the stage swap procedure described above. Substrate stage C, which has a substrate whose exposure is only half completed moves out from under the second imaging location. The substrate on substrate stage A has finished exposing at the first imaging location, and substrate stage C continues over to displace substrate stage A at the first imaging location, via the stage swap procedure described above, and via a path shown in FIG. 9d that is different from the path shown in FIG. 8d, so that the second half of the exposure of the substrate on stage C is completed at the first imaging station, i.e. under leg 1 of the sumo lens (FIG. 9d). This step prevents the cable from one substrate stage from interfering with (i.e. wrapping about the cable from another substrate stage). Substrate stage A moves left and down to the single load/unload station.

In FIG. 9e, the substrate on substrate stage A has finished metrology at the metrology region, and substrate stage A moves to the first imaging location under leg 1 of the Sumo lens, to displace substrate stage C (via the stage swap procedure described above) which has a substrate whose exposure is finished, and to begin exposure of the substrate on substrate stage A at the first imaging location. As further seen from FIG. 9e, after the substrate on stage C has been fully imaged, Substrate stage C moves to the single load/unload station via a path by which it passes through the metrology region. Substrate stage B stays under leg 2 at the second imaging location, to enable exposure of the second half of the substrate on substrate stage B. Thus, the cycle has returned the substrate stages to the positions shown in FIG. 9a and the cycle begins anew. Only a single substrate load/unload station is used for loading and unload all three substrate stages, and only a single metrology region is provided, that is located between the two legs of the Sumo lens and does not interfere with the two substrates that are being imaged simultaneously on either side of the metrology region.

Thus, in an optical imaging process of the invention, the system set up can be provided as shown in FIGS. 8a-8e and 9a-9e, using a single load/unload station, and the substrate stage movement patterns described above. The general movement patterns for each of the three substrate stages comprises movement of a substrate stage from a loading station to a metrology station, movement of the stage from the metrology station to one of a pair of imaging locations and movement of the stage from the one of the pair of imaging locations, to the other of the pair of imaging locations or to the single load/unload station.

More specifically, in the alternative systems of FIGS. 8a-8e and 9a-9e, the movement patterns of the three substrate stages, and imaging of substrates at the pair of imaging locations, comprises
a. beginning imaging of a substrate on a first stage at a first imaging location, while a substrate on a second stage is being imaged at a second imaging location, and a substrate is being loaded to a third substrate stage at the single load/unload station;
b. moving the third substrate stage to a metrology region, while finishing imaging of a substrate on the second substrate stage at the second imaging location, and imaging of a substrate on the first substrate stage continues at the first imaging location;
c. as imaging of a substrate on the second stage is finished at the second imaging location, the third stage moves a substrate from the metrology region to the second imaging location, where partial imaging of the substrate on the third stage begins, the second stage moves a finished substrate to the single load/unload location, where the finished substrate is unloaded from the second stage and a new substrate is loaded on the second stage and moved by the second substrate stage to the metrology region;
d. as the new substrate on the second substrate stage finishes at the metrology region, the second substrate stage moves to the second imaging location, to displace the third substrate stage (where substrate imaging is partially completed), imaging of a substrate on the first substrate stage has been finished at the first imaging location, the first substrate stage moves to the single load/unload station, and the third substrate stage moves to the first imaging location where imaging of a substrate on the third substrate stage is in the process of being completed;
e. a finished substrate is unloaded from the first substrate stage, a new substrate is loaded to the first substrate stage which moves to the metrology region, as imaging of the substrate on the third substrate staged is completed at the first imaging location, and imaging of a substrate on the second substrate stage is continuing at the second imaging location;
f. as metrology of a substrate on the first substrate stage is completed, the first substrate stage moves to the first imaging location, where imaging of the substrate on the first substrate stage begins, and the third substrate stage moves the finished substrate on the third substrate stage to the single load/unload station; and
g. this returns the cycle to the state described in section a above, where the cycle of processing of substrates on the first, second and third substrate stages can continue in the manner described above.

As with the prior system set up and substrate stage movement patterns, another way of viewing the moving pattern of the substrate stages is as follows:
a. the movement pattern of the first substrate stage is such that the first substrate stage moves in a pattern from the first imaging location to the single load/unload station, to the metrology region and then back to the first imaging station, and imaging of the entire substrate on the first substrate stage is effected at the first imaging location;
b. the movement pattern of the second substrate stage is such that the second substrate stage moves from the second imaging location to the single load/unload station, to the metrology region and then back to the second imaging station, and imaging of the entire substrate on the second substrate stage is effected at the second imaging location; and
c. the movement pattern of the third substrate stage is such that the third substrate stage moves from the single load/unload station to the metrology region, then to the second imaging location where partial imaging of the substrate on the third substrate stage is effected, and then in the direction of the linear alignment to the first imaging location, where completion of imaging of the substrate on the third substrate stage is effected.

As will be apparent to those in the art, the foregoing movement patterns of the three substrate stages, as shown and described with respect to FIGS. 8a-8e and 9a-9e, is designed to avoid one substrate stage (and particularly the cable associated with that substrate stage) from interfering with (e.g. wrapping about the cable associated with) the movement pattern of any of the other substrate stages. Also, while the embodiments of FIGS. 8a-e and 9a-e show a single substrate load/unload station, the movements of the substrate stages that are shown and described in connection with systems and methods with a plurality of substrate load/unload stations (e.g. FIGS. 2 and 3a-e), as will be clear to those in the art.

In addition, the principles shown and described in connection with FIGS. 4-7 can also be used in connection with system set ups and movement patterns as described in connection with FIGS. 8a-8e and 9a-9e, in relation to DMI beams that could be affected by the linear alignment of metrology region and imaging locations to address any issues that may need to be addressed on account of the linear alignment.

Also, as will also be clear to those in the art, in applicants' method, the Sumo lens effectively provides first and second optical imaging systems, each of which images the reticle to a substrate on a stage at the imaging location of a respective one of the optical imaging systems. Applicants' method provides for
a. imaging substrates on a first substrate stage with the reticle using a first optical imaging system;
b. imaging substrates on a second substrate stage with the reticle using a second optical imaging system; and
c. periodically imaging substrates on a third substrate stage with the reticle using either the first imaging system or the second optical imaging system.

Moreover, applicant's method provides imaging substrates on the third substrate stage with the reticle using either the first optical imaging system or the second optical imaging system, in a manner that
a. partially exposing a substrate on the third substrate stage using the first optical imaging system; and
b. exposing the remainder of the substrate on the third substrate stage using the second optical imaging system.

Still further applicants' method provides
a. periodically exchanging the substrates on the first substrate stage; and
b. partially exposing the substrates on the third substrate stage using the first optical imaging system when periodically exchanging the substrates on the first wafer stage.

Additionally, applicants' method provides for
a. periodically exchanging the substrates on the second substrate stage; and
b. exposing the remainder of the substrates on the third substrate stage using the second optical imaging system when periodically exchanging the substrates on the first substrate stage.

Accordingly, the foregoing description shows a new and useful processing principle for simultaneous imaging of a pair of substrates, in a manner that makes efficient use of an optical imaging system with the capability to image a single reticle to a pair of imaging locations, and address the types of substrate stage movement patterns to accomplish such imaging in an efficient and effective manner. With the foregoing principles of the invention in mind, various ways to implement such a process, according to the principles of the present invention, will become apparent to those in the art.

1. An optical imaging process for imaging a plurality of substrates, comprising
a. providing optical imaging of a reticle at two imaging locations, and
b. imaging substrates by moving the stages for the substrates in patterns whereby (i) a substrate on at least one stage is partially imaged at one imaging location and then partially imaged at the other imaging location, and (ii) the movement of the stages of the substrates is configured to avoid interference between movement of any one substrate stage with movement of any of the other substrate stages.

2. The optical imaging process of claim 1, wherein each substrate stage has cabling connected therewith, and the movement patterns of the stages of the three substrates is configured to avoid movement of the stages in paths that would cause the cabling associated with one substrate stage to interfere with the cabling or other parts of any of the other substrate stages.

3. The optical imaging process of claim 1, wherein at least one metrology region is provided for examining a substrate, and wherein the movement patterns of the substrate stages is configured such that as one substrate is being examined at the metrology region, respective parts of the other two substrates are being imaged at the two imaging locations.

4. The optical imaging process of claim 1, wherein one or more substrate load/unload stations are provided.

5. The optical imaging process of claim 4, and wherein the movement patterns of the first, second and third substrate stages and processing of substrates on the first, second and third substrates stages comprises
a. the first substrate stage moves between the first imaging location, one of the load/unload station(s), and a metrology region;
b. the second substrate stage moves between the second imaging location, one of the load/unload station(s), and a metrology region; and
c. the third substrate stage moves between one of the load/unload station(s), a metrology region, the second imaging location, and the first imaging location.

6. The optical imaging process of claim 5, wherein a single load/unload station is provided, and that single load/unload station comprises the load/unload station for each of the first, second and third substrate stages.

7. The optical imaging processes of claim 4, wherein a plurality of substrate load/unload stations are provided.

8. The optical imaging process of claim 7, wherein one of the plurality of substrate load/unload stations is configured to enable load/unload of a substrate from one or more of the substrate stages.

9. The optical imaging process of claim 1, wherein the movement patterns of the substrate stages are configured to provide that a pair of the substrate stages are located at the pair of imaging locations a majority of the time, so that imaging is being simultaneously performed at the pair of imaging locations at a majority of the time.

10. A method for imaging substrates, comprising
a. providing a reticle;
b. imaging substrates on a first substrate stage with the reticle using a first optical imaging system;
c. imaging substrates on a second substrate stage with the reticle using a second optical imaging system; and
d. imaging substrates on a third substrate stage with the reticle using either the first imaging system or the second optical imaging system.

11. The method of claim 10, wherein imaging substrates on the third substrate stage with the reticle using either the first optical imaging system or the second optical imaging system further comprises:
a. partially exposing a substrate on the third substrate stage using the first optical imaging system; and
b. exposing the remainder of the substrate on the third substrate stage using the second optical imaging system.

12. The method of claim 11, further comprising:
c. periodically exchanging the substrates on the first substrate stage; and
d. partially exposing the substrates on the third substrate stage using the first optical imaging system when periodically exchanging the substrates on the first wafer stage.

13. The method of claim 12, further comprising:
a. periodically exchanging the substrates on the second substrate stage; and
b. exposing the remainder of the substrates on the third substrate stage using the second optical imaging system when periodically exchanging the substrates on the first substrate stage.

14. The method of claim 10, wherein one or more substrate load/unload stations are provided.

15. The method of claim 14, wherein at least one metrology region is provided, and wherein the movement patterns of the first, second and third substrate stages and processing of substrates on the first, second and third substrates stages comprises
a. the first substrate stage moves between the first imaging location, a substrate load/unload station, and a metrology region;
b. the second substrate stage moves between the second imaging location, a substrate load/unload station, and a metrology region; and
c. the third substrate stage moves between a substrate load/unload station, a metrology region, the second imaging location, and the first imaging location.

16. The method of claim 15, wherein a single load/unload station is provided, and that single load/unload station comprises the load/unload station for each of the first, second and third substrate stages.

17. The method of claim 15, wherein a plurality of substrate load/unload stations are provided.

18. The method of claim 17, wherein one of the plurality of substrate load/unload stations is configured to enable load/unload of a substrate from one or more of the substrate stages.

19. The method of claim 15, wherein the movement patterns of the substrate stages is configured to provide that a pair of the substrate stages are at the first and second optical imaging systems a majority of the time, so that imaging is being simultaneously performed at the pair of optical imaging systems at a majority of the time.
